(19) United States
(12) Patent Application Publication
(10) Pub. No.: US 2021/0208584 A1
(43) Pub. Date: Jul. 8, 2021

(54) MOVING BODY CONTROL DEVICE, MOVING BODY CONTROL METHOD, AND COMPUTER READABLE RECORDING MEDIUM

(71) Applicant: TOYOTA JIDOSHA KABUSHIKI KAISHA, Toyota-shi (JP)

(72) Inventors: Kotomi TESHIMA, Gotemba-shi (JP); Hitoshi KUMON, Aichi-gun (JP); Kazuhiro ITOU, Mishima-shi (JP); Yoshie MIKAMI, Mishima-shi (JP); Yuta MANIWA, Susono-shi (JP)

(73) Assignee: TOYOTA JIDOSHA KABUSHIKI KAISHA, Toyota-shi (JP)

(21) Appl. No.: 17/112,062

(22) Filed: Dec. 4, 2020

(30) Foreign Application Priority Data
Jan. 7, 2020 (JP) 2020-001079

(51) Int. Cl. G05D 1/00; G02B 27/01

(52) U.S. Cl. CPC G05D 1/0044; G05D 1/0016; G02B 2027/0178; G05D 2201/0213; G02B 27/0172

(57) ABSTRACT

A moving body control device includes a processor including hardware, the processor being configured to: acquire spatial information of at least one of an outside and inside of a moving body; generate a virtual image including the information of the at least one of the outside and inside of the moving body based on the spatial information; output the generated virtual image to a display unit visually recognizable by a user who rides on the moving body; acquire a detection result of a predetermined action of the user when the user performs an action; update and output the virtual image based on the action of the user in the detection result; and output a control signal for the moving body, the control signal being based on the detection result.

The present application claims priority to and incorporates by reference the entire contents of Japanese Patent Application No. 2020-001079 filed in Japan on Jan. 7, 2020.

### BACKGROUND

The present disclosure relates to a moving body control device, a moving body control method, and a computer readable recording medium.

A technique for operating a vehicle by a gesture is known (for example, see JP 2018-172028 A). In the technique disclosed in JP 2018-172028 A, at the time of executing autonomous driving of a vehicle after disabling operations of driving operators such as an accelerator pedal and a steering wheel, when a gesture or the like of a user's hand, which is imaged by an imaging device or the like, is input to a control unit, acceleration/deceleration and steering in the vehicle are controlled to change a travel route.

### SUMMARY

In the technique disclosed in JP 2018-172028 A, in place of driving by a user who operates the driving operators, the acceleration/deceleration and steering of the vehicle are controlled based on the gesture of the user. Therefore, though a driver of a moving body such as a vehicle has been able to enjoy driving, it has been difficult for other passengers who ride on this moving body to enjoy the pleasure of riding on the moving body. Moreover, it has been difficult for the driver to enjoy the pleasure of riding on the moving body when it is necessary to intermittently stop the operation of the moving body, for example, such as during a traffic congestion. From these points, there has been a demand for a technology that allows a user who rides on a moving body to enjoy the pleasure of riding on the same.

There is a need for a moving body control device, a moving body control method, and a computer readable recording medium, which allow a user who rides on a moving body to enjoy the pleasure of riding on the same.

According to one aspect of the present disclosure, there is provided a moving body control device including a processor including hardware, the processor being configured to: acquire spatial information of at least one of an outside and inside of a moving body; generate a virtual image including the information of the at least one of the outside and inside of the moving body based on the spatial information; output the generated virtual image to a display unit visually recognizable by a user who rides on the moving body; acquire a detection result of a predetermined action of the user when the user performs an action; update and output the virtual image based on the action of the user in the detection result; and output a control signal for the moving body, the control signal being based on the detection result.

### BRIEF DESCRIPTION OF THE DRAWINGS

FIG. 1 is a schematic diagram illustrating a schematic configuration of a moving body control system according to an embodiment;

FIG. 2 is a perspective transparent view illustrating an example of a moving body on which an occupant rides, the occupant wearing a wearable device including a moving body control device according to the embodiment;

FIG. 3 is a block diagram illustrating a functional configuration of a vehicle terminal device according to the embodiment;

FIG. 4 is a diagram illustrating a schematic configuration of a first wearable device according to the embodiment;

FIG. 5 is a block diagram illustrating a functional configuration of the first wearable device according to the embodiment;

FIG. 6 is a flowchart illustrating an overview of processing executed by the wearable device according to the embodiment;

FIG. 7 is a view schematically illustrating an example of a virtual image generated by a generation unit according to the embodiment;

FIG. 8 is a view schematically illustrating an example of a bird's-eye-view virtual image generated by the generation unit according to the embodiment;

FIG. 9 is a block diagram illustrating a functional configuration of a moving body terminal device according to a first modification of the embodiment;

FIG. 10 is a view illustrating a schematic configuration of a second wearable device according to a second modification of the embodiment;

FIG. 11 is a block diagram illustrating a functional configuration of the second wearable device according to the second modification of the embodiment;

FIG. 12A is a view for explaining an example of a user's action and an example of a virtual image visually recognized by the user according to a third modification of the embodiment;

FIG. 12B is a view for explaining an example of a user's action and an example of a virtual image visually recognized by the user according to a fourth modification of the embodiment;

FIG. 12C is a view for explaining an example of a user's action and an example of a virtual image visually recognized by the user according to a fifth modification of the embodiment;

FIG. 12D is a view for explaining an example of a user's action and an example of a virtual image visually recognized by the user according to a sixth modification of the embodiment;

FIG. 12E is a view for explaining an example of a user's action and an example of a virtual image visually recognized by the user according to a seventh modification of the embodiment;

FIG. 13 is a view illustrating a schematic configuration of a wearable device according to another embodiment;

FIG. 14 is a view illustrating a schematic configuration of a wearable device according to another embodiment;

FIG. 15 is a view illustrating a schematic configuration of a wearable device according to another embodiment; and

FIG. 16 is a view illustrating a schematic configuration of a wearable device according to another embodiment.

### DETAILED DESCRIPTION

Hereinafter, an embodiment will be described with reference to the drawings. Note that the same reference numerals are assigned to the same or corresponding portions in all the drawings of the following embodiments. Moreover, the present disclosure is not limited by the embodiments to be described below.

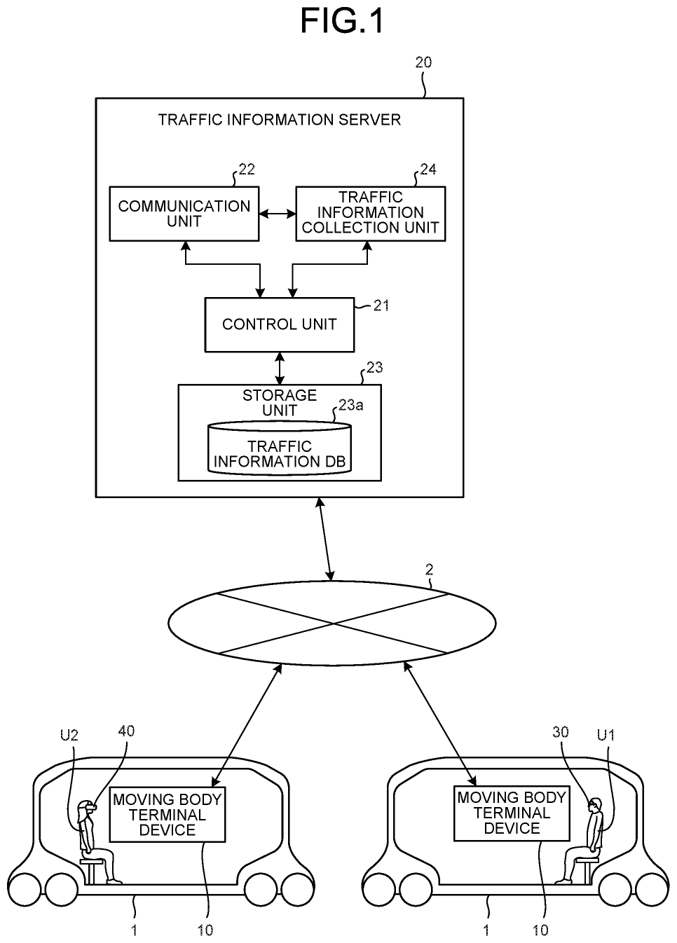

First, a moving body control device according to the embodiment will be described. FIG. 1 is a schematic diagram illustrating a schematic configuration of a moving body control system including the moving body control device according to the embodiment.

As illustrated in FIG. 1, the moving body control system includes, for example, moving body terminal devices 10 each of which is mounted on a moving body 1. A user U1 wearing a first wearable device 30 or a user U2 wearing a second wearable device 40 is riding on the moving body 1. The moving body control system may further include a traffic information server 20 connected via a network 2. In this case, each moving body terminal device 10 is capable of communicating with the traffic information server 20 via the network 2. Note that, in the present specification, the wearable device means a device wearable by the user, and may or may not include a display unit that displays an image.

The traffic information server 20 collects traffic information on a road and acquires information about traffic or the like on the road. The traffic information server 20 includes a control unit 21, a communication unit 22, a storage unit 23, and a traffic information collection unit 24.

The control unit 21 specifically includes a processor such as a central processing unit (CPU), a digital signal processor (DSP), and a field-programmable gate array (FPGA), and a main storage unit such as a random access memory (RAM) and a read only memory (ROM).

The communication unit 22 is composed by using a communication module capable of wired communication or wireless communication, the communication module being, for example, a local area network (LAN) interface board, a wireless communication circuit for wireless communication, or the like. The LAN interface board or the wireless communication circuit may connect to the network 2, such as the Internet, as a public communication network. Moreover, the communication unit 22 may be made capable of communicating with the outside in accordance with a predetermined communication standard, for example, 4G, 5G, Wireless Fidelity (Wi-Fi) (registered trademark), Bluetooth (registered trademark), or the like. The communication unit 22 may connect to the network 2 and communicate with the moving body terminal device 10 or the like. The communication unit 22 may connect to the network 2 and communicate with beacons or the like, which acquire traffic information. The communication unit 22 transmits the traffic information to the moving body terminal device 10 as needed. Note that information transmitted by the communication unit 22 is not limited to such information.

The storage unit 23 is composed of a storage medium selected from an erasable programmable ROM (EPROM), a hard disk drive (HDD), a solid state drive (SSD), a removable medium, and the like. Note that the removable medium is, for example, a universal serial bus (USB) memory or a disc recording medium such as a compact disc (CD), a digital versatile disc (DVD), and a Blu-ray disc (BD) (registered trademark). In the storage unit 23, it is possible to store an operating system (OS), various programs, various tables, various databases, and the like.

The control unit 21 loads a program stored in the storage unit 23 into a work area of the main storage unit, executes the program, and controls respective component units and the like through the execution of the program. Thus, the control unit 21 may achieve a function that meets a predetermined purpose. The storage unit 23 stores a traffic information database 23a.

Via the communication unit 22, the traffic information collection unit 24 collects traffic information from, for example, radio signs such as beacons placed on a road or the like. The traffic information collected by the traffic information collection unit 24 is stored in the traffic information database 23a of the storage unit 23 so as to be searchable. Note that the traffic information collection unit 24 may further include a storage unit. Moreover, the traffic information collection unit 24, the control unit 21, the communication unit 22, and the storage unit 23 may be composed separately from one another.

In the moving body control system, the first wearable device 30 and the second wearable device 40 may be made communicable with each other via the network 2. Moreover, another server communicable with the moving body terminal device 10, the first wearable device 30, and the second wearable device 40 via the network 2 may be provided. In the following, a description will be given of a vehicle, and particularly, an autonomous driving vehicle capable of autonomous travel, which is taken as an example of the moving body 1; however, the present disclosure is not limited to this, and the moving body 1 may be a vehicle, a motorcycle, a drone, an airplane, a ship, a train, or the like, which travels by being driven by a driver.

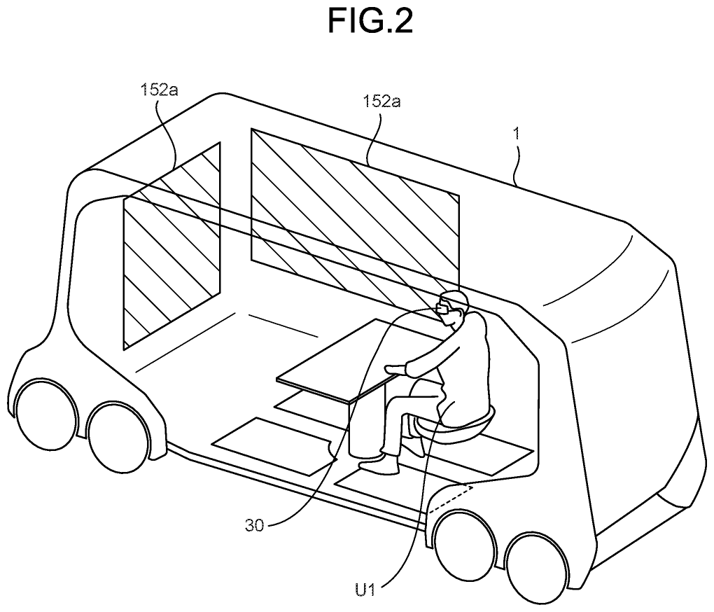

FIG. 2 is a perspective transparent view illustrating an example of the moving body according to the embodiment. In FIG. 2, the user U1 wearing the first wearable device 30 including the moving body control device is riding on the moving body 1.

As illustrated in FIG. 2, the moving body 1 is provided with a seat on which the user U1 is seated when riding and display units 152a on which predetermined information is displayed. In FIG. 2, the user U1 wears the first wearable device 30, but does not necessarily have to wear the same. When the moving body 1 is a vehicle driven by a driver, driving operators such as a steering wheel, an accelerator pedal and a brake pedal are provided.

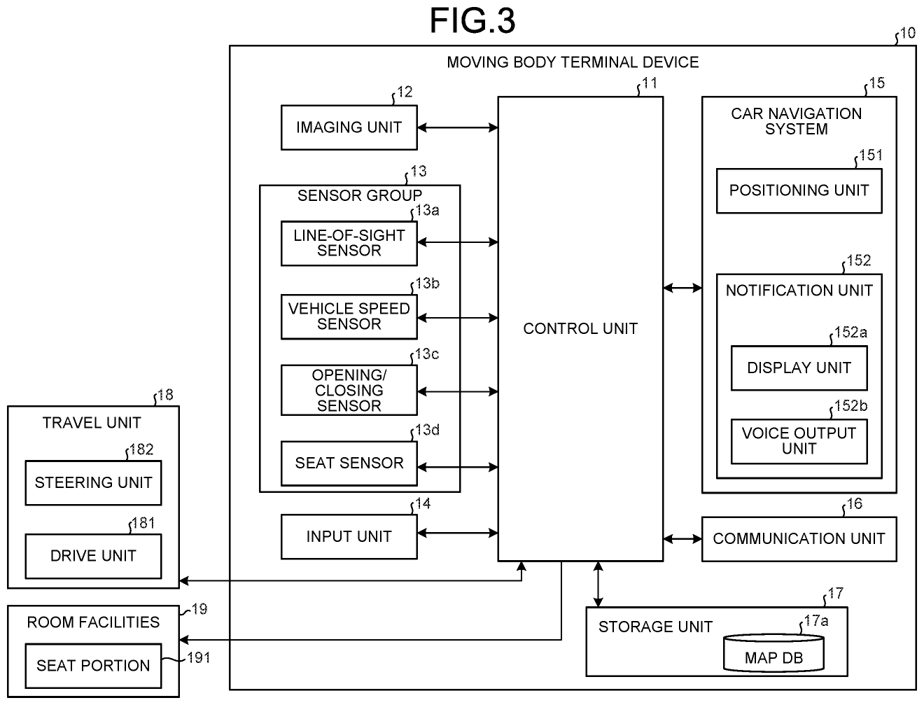

FIG. 3 is a block diagram illustrating a functional configuration of the moving body 1 according to the embodiment. As illustrated in FIG. 3, the moving body 1 such as a vehicle includes, for example, a moving body terminal device 10, a travel unit 18, and room facilities 19. The moving body terminal device 10 controls the travel of the moving body 1 in cooperation with the travel unit 18 including another electronic control unit (ECU) of the moving body 1. When the moving body terminal device 10 includes a control program for the autonomous driving, the autonomous driving may be continued by controlling the travel unit 18. The moving body terminal device 10 is composed to be capable of controlling respective portions of the room facilities 19.

The moving body terminal device 10 includes a control unit 11, an imaging unit 12, a sensor group 13, an input unit 14, a car navigation system 15, a communication unit 16, and a storage unit 17. The sensor group 13 includes a line-of-sight sensor 13a, a vehicle speed sensor 13b, an opening/closing sensor 13c, and a seat sensor 13d.

The control unit 11 and the storage unit 17 have physically similar configurations to those of the control unit 21 and the storage unit 23, which are mentioned above. The control unit 11 controls respective components of the moving body terminal device 10 in a centralized manner, and also controls the travel unit 18, thereby controlling operations of various components mounted on the moving body 1 in the centralized manner. The storage unit 17 stores a map database 17a composed of various map data.

The communication unit 16 as a communication terminal of the moving body 1 may be composed of, for example, a data communication module (DCM) or the like, which communicates with an external server, for example, the traffic information server 20 or the like by wireless communication made via the network 2. The communication unit 16 may perform road-vehicle communication of communicating with antennas or the like, which are placed on the road. That is, the communication unit 16 may perform the road-vehicle communication or the like with the beacons or the like, which acquire traffic information. The communication unit 16 may perform inter-vehicle communication of communicating with a communication unit 16 of another moving body 1. The road-vehicle communication and the inter-vehicle communication may be performed via the network 2. Moreover, the communication unit 16 is composed to be communicable with an external device in accordance with a predetermined communication standard, for example, 4G, 5G, Wireless Fidelity (Wi-Fi) (registered trademark), Bluetooth (registered trademark), or the like. The communication unit 16 receives traffic information from the traffic information server 20 via the network 2 as needed. Note that the information transmitted and received by the communication unit 16 is not limited to such information.

By the control of the control unit 11, the communication unit 16 communicates with various devices in accordance with the above-mentioned predetermined communication standard. Specifically, under the control of the control unit 11, the communication unit 16 may transmit and receive various information to and from the first wearable device 30 worn by the user U1 who rides on the moving body 1. Moreover, the communication unit 16 is capable of transmitting and receiving various information to and from the other moving body 1 and the second wearable device 40 worn by the user U2. Note that the predetermined communication standard is not limited to the above-mentioned standards.

A plurality of the imaging units 12 are provided outside the moving body 1. For example, the imaging units 12 may be provided at four positions of the moving body 1, which are forward, backward and both-side positions thereof, so that a shooting angle of view becomes 360°. Furthermore, a plurality of the imaging units 12 may be provided inside the moving body 1. Under the control of the control unit 11, the imaging units 12 individually capture an external space and internal space of the moving body 1, thereby generating image data in which the external space and the internal space are reflected, and outputting the generated image data to the control unit 11. The imaging unit 12 is composed by using an optical system and an image sensor. The optical system is composed by using one or more lenses. The image sensor is composed of a charge coupled device (CCD), a complementary metal oxide semiconductor (CMOS), or the like, which receives a subject image formed by the optical system, thereby generating image data.

The sensor group 13 is composed by including various sensors. For example, the line-of-sight sensor 13a detects line-of-sight information including a line of sight and retina of the user U1 who rides on the moving body 1, and outputs the detected line-of-sight information to the control unit 11. The line-of-sight sensor 13a is composed by using an optical system, a CCD or CMOS, a memory, and a processor including hardware such as a CPU and a graphics processing unit (GPU). For example, by using known template matching, the line-of-sight sensor 13a detects, as a reference point, an unmovable portion of an eye of the user U1, for example, such as the head corner of the eye, and detects, as a moving point, a movable portion of the eye, for example, such as the iris. The line-of-sight sensor 13a detects the line of sight of the user U1 based on a positional relationship between the reference point and the moving point, and outputs a detection result to the control unit 11. The line-of-sight sensor 13a may detect retinal veins of the user U1, and may output a detection result to the control unit 11.

Note that, although the line of sight of the user U1 is detected by a visible camera as the line-of-sight sensor 13a in the embodiment, the present disclosure is not limited to this, and the line of sight of the user U1 may be detected by an infrared camera. In a case in which the line-of-sight sensor 13a is composed of an infrared camera, infrared light is applied to the user U1 by means of an infrared light emitting diode (LED) or the like, a reference point (for example, corneal reflection) and a moving point (for example, a pupil) are detected from image data generated by capturing an image of the user U1 by using the infrared camera, and the line of sight of the user U1 is detected based on a positional relationship between the reference point and the moving point.

The vehicle speed sensor 13b detects a vehicle speed of the moving body 1 during traveling, and outputs a detection result to the control unit 11. The opening/closing sensor 13c detects opening/closing of a door through which the user goes in and out, and outputs a detection result to the control unit 11. The opening/closing sensor 13c is composed by using, for example, a push switch or the like. The seat sensor 13d detects a seated state of each seat, and outputs a detection result to the control unit 11. The seat sensor 13d is composed by using a load detection device, a pressure sensor or the like, which is placed below a seat surface of each seat provided in the moving body 1.

The input unit 14 is composed of, for example, a keyboard, a touch panel keyboard that is incorporated into the display unit 152a and detects a touch operation on a display panel, a voice input device that enables a call with the outside, or the like. Here, the call with the outside includes not only a call with another moving body terminal device 10 but also, for example, a call with an operator who operates an external server or an artificial intelligence system, or the like. When the input unit 14 is composed of a voice input device, the input unit 14 receives an input of a voice of the user U1, and outputs audio data, which corresponds to the received voice, to the control unit 11. The voice input device is composed by using a microphone, an A/D conversion circuit that converts, into audio data, a voice received by the microphone, an amplifier circuit that amplifies the audio data, and the like. Note that a speaker microphone capable of outputting a sound may be used instead of the microphone.

The car navigation system 15 includes a positioning unit 151 and a notification unit 152. The positioning unit 151 receives, for example, signals from a plurality of global positioning system (GPS) satellites and transmission antennas, and calculates a position of the moving body 1 based on the received signals. The positioning unit 151 is composed by using a GPS receiving sensor and the like. Orientation accuracy of the moving body 1 may be improved by mounting a plurality of the GPS receiving sensors or the like, each of which forms the positioning unit 151. Note that a method in which light detection and ranging/laser imaging detection and ranging (LiDAR) is combined with a three-dimensional digital map may be adopted as a method of detecting the position of the moving body 1. The notification unit 152 includes a display unit 152a that displays an image, a video, and character information, and a voice output unit 152b that generates a sound such as a voice and an alarm sound. The display unit 152a is composed by using a display such as a liquid crystal display and an organic electroluminescence (EL) display. The voice output unit 152b is composed by using a speaker and the like.

The car navigation system 15 superimposes a current position of the moving body 1, which is acquired by the positioning unit 151, on the map data stored in the map database 17a of the storage unit 17. Thus, the car navigation system 15 may notify the user U1 of information including a road on which the moving body 1 is currently traveling, a route to a destination, and the like by at least one of the display unit 152a and the voice output unit 152b. The display unit 152a displays characters, figures and the like on a screen of the touch panel display under the control of the control unit 11. Note that the car navigation system 15 may include the input unit 14. In this case, the display unit 152a, the voice output unit 152b, and the input unit 14 may be composed of a touch panel display, a speaker microphone, and the like, and the display unit 152a may be caused to function while including a function of the input unit 14. Under the control of the control unit 11, the voice output unit 152b outputs a voice from the speaker microphone, thereby notifying the outside of predetermined information, and so on.

Note that the moving body 1 may include a key unit that performs, as a short-range radio communication technology, authentication that is based on, for example, blue tooth low energy (BLE) authentication information with the user terminal device owned by the user, and executes locking and unlocking of the moving body 1.

The travel unit 18 includes a drive unit 181 and a steering unit 182. The drive unit 181 includes a drive device necessary for traveling of the moving body 1, and a drive transmission device that transmits drive to wheels and the like. Specifically, the moving body 1 includes a motor or an engine as a drive source. The motor is driven by electric power from a battery. The engine is composed to be capable of generating electricity by using an electric motor or the like by being driven by combustion of fuel. The generated electric power is charged in a rechargeable battery. The moving body 1 includes a drive transmission mechanism that transmits driving force of the drive source, drive wheels for traveling, and the like. The steering unit 182 changes a steering angle of the wheels serving as steered wheels, and determines a traveling direction and orientation of the moving body 1.

The room facilities 19 include a seat portion 191 having a reclining function, for example. Note that the room facilities 19 may further include an air conditioner, a vehicle interior light, a table, and the like.

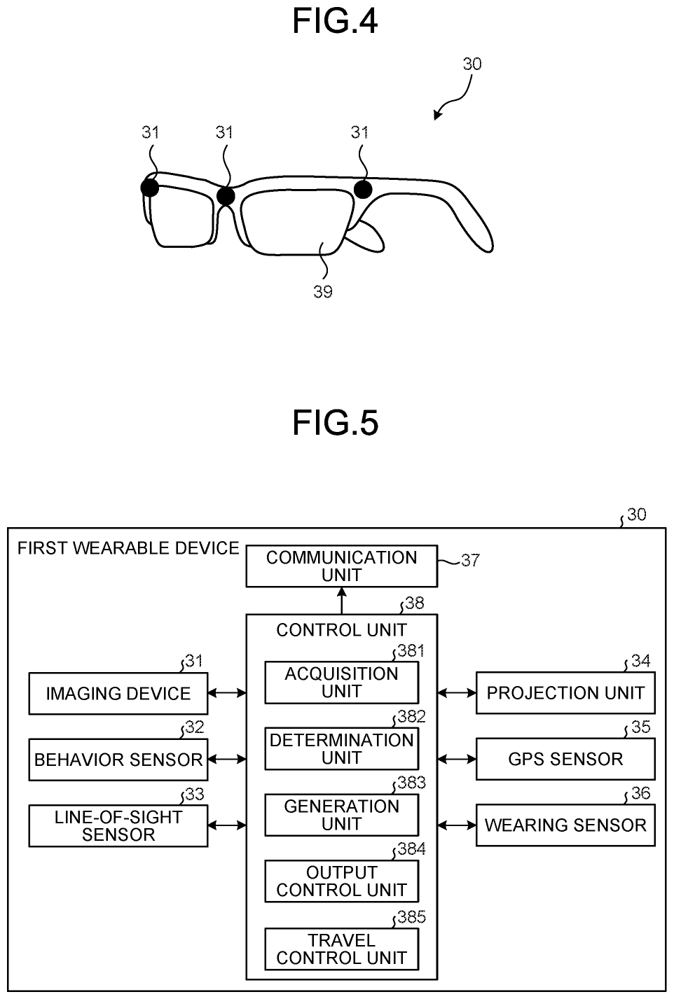

Next, a description will be given of a configuration of the first wearable device 30. FIG. 4 is a view illustrating a schematic configuration of the first wearable device 30. FIG. 5 is a block diagram illustrating a functional configuration of the first wearable device 30.

The first wearable device 30 including the moving body control device, which is illustrated in FIGS. 4 and 5, is a so-called augmented reality (AR) glass for performing AR. The first wearable device 30 virtually displays an image, a video, character information and the like in a field of view of the user U1. Note that, in the present specification, such a virtual image, a video, character information and the like may be collectively referred to as virtual images. The first wearable device 30 includes imaging devices 31, a behavior sensor 32, a line-of-sight sensor 33, a projection unit 34, a GPS sensor 35, a wearing sensor 36, a communication unit 37, and a control unit 38.

As illustrated in FIG. 4, a plurality of the imaging devices 31 as first sensors are provided in the first wearable device 30. Under control of the control unit 38, the imaging devices 31 capture an image along the line of sight of the user U1, thereby generating image data, and then output the image data to the control unit 38. Each of the imaging devices 31 is composed by using an optical system including one or more lenses, and an image sensor such as a CCD or CMOS.

As illustrated in FIG. 5, the behavior sensor 32 as a second sensor detects behavior information regarding a behavior of the user U1 wearing the first wearable device 30, and outputs a detection result to the control unit 38. Specifically, the behavior sensor 32 detects an angular velocity and an acceleration, which are generated in the first wearable device 30, as such behavior information, and outputs a detection result to the control unit 38. Moreover, the behavior sensor 32 detects an absolute direction as the behavior information by detecting geomagnetism, and outputs a detection result to the control unit 38. The behavior sensor 32 may be composed by using a three-axis gyro sensor, a three-axis acceleration sensor, a three-axis geomagnetic sensor (electronic compass) and the like.

The line-of-sight sensor 33 detects an orientation of the line of sight of the user U1 wearing the first wearable device 30, and outputs a detection result to the control unit 38. The line-of-sight sensor 33 is composed by using an optical system, an image sensor such as a CCD and a CMOS, a memory, and a processor including hardware such as a CPU. For example, by using known template matching, the line-of-sight sensor 33 detects, as a reference point, an unmovable portion of the eye of the user U1, for example, such as the head corner of the eye, and detects, as a moving point, a movable portion of the eye, for example, such as the iris. The line-of-sight sensor 33 detects the orientation of the line of sight of the user U1 based on a positional relationship between the reference point and the moving point.

Under the control of the control unit 38, the projection unit 34 as a display unit projects a virtual image of an image, a video, character information and the like toward the retina of the user U1 wearing the first wearable device 30. The projection unit 34 is composed by using a red, green and blue (RGB) laser, a micro-electro-mechanical systems (MEMS) mirror, a reflecting mirror, and the like. The RGB laser emits laser beams of respective RGB colors. The MEMS mirror reflects the laser beams. The reflecting mirror projects the laser beams, which are reflected from the MEMS mirror, onto the retina of the user U1. Note that the projection unit 34 may be a unit that causes a lens 39 of the first wearable device 30 to display a virtual image by projecting the virtual image thereon under the control of the control unit 38.

The GPS sensor 35 calculates position information about a position of the first wearable device 30 based on signals received from the plurality of GPS satellites, and outputs the calculated position information to the control unit 38. The GPS sensor 35 is composed by using a GPS receiving sensor and the like.

The wearing sensor 36 detects a wearing state of the user U1, and outputs a detection result to the control unit 38. The wearing sensor 36 is composed by using a pressure sensor that detects a pressure when the user U1 wears the first wearable device 30, a vital sensor that detects vital information of the user U1, such as a body temperature, a pulse, brain waves, a blood pressure, and a sweating state, and the like.

The communication unit 37 is composed by using a communication module capable of wireless communication. Under the control of the control unit 38, the communication unit 37 transmits and receives various information to and from the moving body terminal device 10 in accordance with the above-mentioned predetermined communication standard.

The control unit 38 physically has a configuration similar to those of the above-mentioned control units 11 and 21, and is composed by using a memory and a processor including hardware that is any of a CPU, a GPU, an FPGA, a DSP, an ASIC and the like. The control unit 38 controls operations of the respective units which compose the first wearable device 30. The control unit 38 includes an acquisition unit 381, a determination unit 382, a generation unit 383, an output control unit 384, and a travel control unit 385. In the embodiment, the control unit 38 functions as a processor of the moving body control device.

The acquisition unit 381 acquires various information from the moving body terminal device 10 via the communication unit 37. The acquisition unit 381 may acquire, for example, traffic information from the moving body terminal device 10, or may acquire the traffic information from the traffic information server 20 via the network 2 and the moving body terminal device 10. The acquisition unit 381 may acquire the behavior information of the user U1, the vital information thereof, and user identification information thereof. Note that the acquisition unit 381 is also able to acquire various information from an external server via the communication unit 37 and the network 2.

The determination unit 382 makes a determination based on the various information acquired by the acquisition unit 381. Specifically, the determination unit 382 may determine, for example, whether or not the travel unit 18 may be controlled, whether or not the user U1 is riding on the moving body 1, whether or not an operation control may be started, whether or not action data based on physical information of the user U1 is input, and so on. Note that the physical information of the user U1 includes the behavior information indicating a behavior thereof, the vital information, the user identification information, the line-of-sight information, and the like. Moreover, the determination unit 382 may also determine whether or not predetermined information is input from the input unit 14 of the moving body terminal device 10. Furthermore, the determination unit 382 may have a trained model generated by machine learning using a predetermined input/output data set, which includes an input parameter for making a determination and an output parameter indicating a determination result. In this case, the determination unit 382 may make the determination based on the output parameter obtained by inputting the input parameter thus input to the trained model.

The control unit 38 causes the projection unit 34 to output a predetermined virtual image in the field of view of the user U1 based on the line-of-sight information of the user U1, which is detected by the line-of-sight sensor 33, and based on the behavior information thereof. That is, the generation unit 383 generates a virtual image viewed from a viewpoint of the user U1 by using spatial information of the moving body 1, which is acquired by the acquisition unit 381. The output control unit 384 controls an output of the virtual image to the projection unit 34, the virtual image being generated by the generation unit 383. Note that details of the virtual image generated by the generation unit 383 will be described later. Based on the action data regarding the action of the user U1, the action data being acquired by the acquisition unit 381, the travel control unit 385 outputs a control signal corresponding to the action data and capable of controlling the travel unit 18 of the moving body 1 via the moving body terminal device 10.

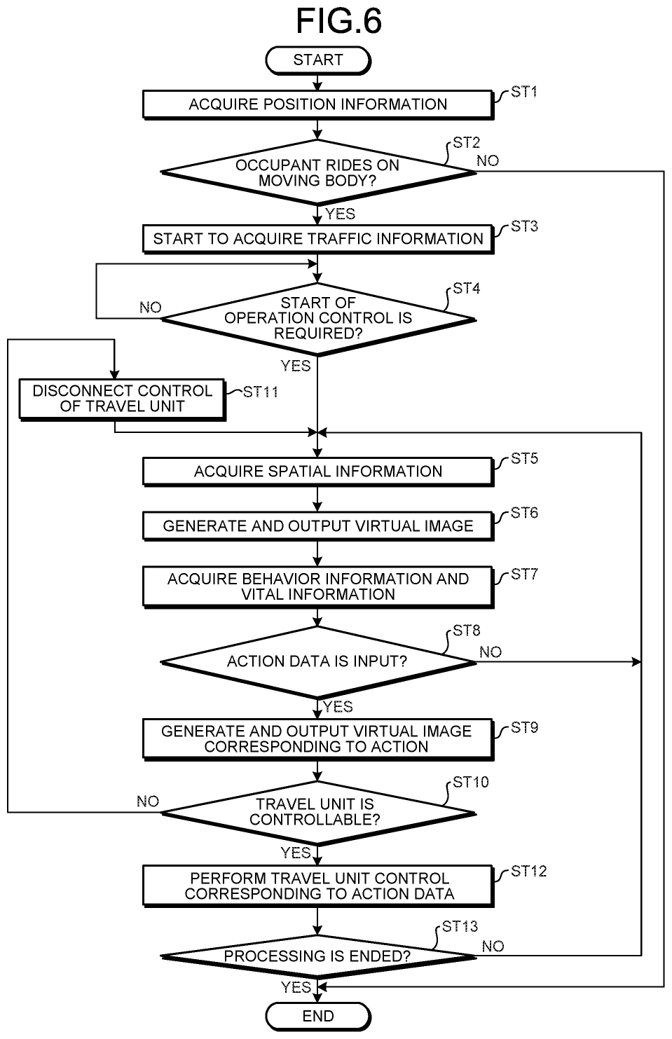

Next, a description will be given of moving body control processing executed by the first wearable device 30. FIG. 6 is a flowchart illustrating an overview of processing executed by the first wearable device 30. In the following description, transmission and reception of various information is performed between the communication unit 16 of the moving body terminal device 10 and the communication unit 37 of the first wearable device 30 directly or via the network 2, and a description of this point will be omitted. Note that, in the embodiment, the moving body 1 is a vehicle controlled by the control unit 11 of the moving body terminal device 10 so as to be capable of autonomous driving, but is not necessarily limited thereto.

As illustrated in FIG. 6, the acquisition unit 381 first acquires the position information of the first wearable device 30 and the position information of the moving body 1 (step ST1). Subsequently, the determination unit 382 determines whether or not the user U1 rides on the moving body 1 based on the position information of the first wearable device 30 and the position information of the moving body 1, which are acquired by the acquisition unit 381 (step ST2). Note that the determination unit 382 may determine whether or not the user U1 rides on the moving body 1 based on the detection result of the opening/closing sensor 13c and the detection result of the seat sensor 13d in the moving body terminal device 10 besides the position information of the first wearable device 30 and the position information of the moving body 1.

When the determination unit 382 determines that the user U1 does not ride on the moving body 1 (step ST2: No), the moving body control processing ends. On the other hand, when the determination unit 382 determines that the user U1 rides on the moving body 1 (step ST2: Yes), the processing proceeds to step ST3.

In step ST3, based on the acquired position information, the acquisition unit 381 starts to acquire traffic information through the road-vehicle communication, the inter-vehicle communication or the like or to acquire traffic information from the traffic information server 20 or the like. Note that such acquisition of the position information and the traffic information by the acquisition unit 381 is continuously executed during the execution of the moving body control processing.

Next, in step ST4, the determination unit 382 determines whether or not the action of the user U1, which is detected by the behavior sensor 32, is an input action of a request signal for requesting the start of the operation control. When the action of the user U1 is an input action of the request signal, the request signal is input to the determination unit 382 in accordance with this action. Note that the request signal for requesting the start of the operation control may be input from the communication unit 16 to the acquisition unit 381 via the communication unit 37 based on the operation of the user U1 for the input unit 14 of the moving body terminal device 10. In the present specification, the operation control refers to the control of the travel unit 18 to make control for the travel of the moving body 1 and the control for an action of an avatar image in the virtual image in the first wearable device 30 in response to the action, utterance and the like of the user U1.

When the determination unit 382 determines that the request signal is not input (step ST4: No), step ST4 is repeatedly executed until the request signal is input. On the other hand, when the determination unit 382 determines that the request signal is input (step ST4: Yes), the processing proceeds to step ST5.

The acquisition unit 381 acquires spatial information regarding at least one of the internal space and external space of the moving body 1 (step ST5). Specifically, via the communication unit 37, the acquisition unit 381 acquires image data, which is generated in such a manner that the imaging unit 12 of the moving body 1 captures the inside of the moving body 1, as spatial information regarding the internal space. The acquisition unit 381 acquires image data, which is generated in such a manner that the imaging unit 12 of the moving body 1 captures the external space of the moving body 1, as spatial information regarding the external space. Furthermore, the acquisition unit 381 acquires image data generated by the capturing of the imaging devices 31 as spatial information. Note that the acquisition unit 381 acquires the image data, which is generated by the imaging unit 12 of the moving body 1, as the spatial information regarding the external space, but the acquisition unit 381 is not limited to this. For example, based on the position information of the moving body 1, the acquisition unit 381 may acquire, as the spatial information regarding the external space, image data around a current position of the moving body 1 from the map data recorded in the map database 17a.

Next, in step ST6, the generation unit 383 generates a virtual image, and the output control unit 384 outputs the generated virtual image to the projection unit 34. Specifically, the generation unit 383 first generates the virtual image viewed from the viewpoint of the user U1 by using the spatial information acquired by the acquisition unit 381. The output control unit 384 outputs the virtual image, which is generated by the generation unit 383, to the projection unit 34. The projection unit 34 projects the input virtual image toward the retina of the user U1. This allows the user U1 to recognize the virtual image.

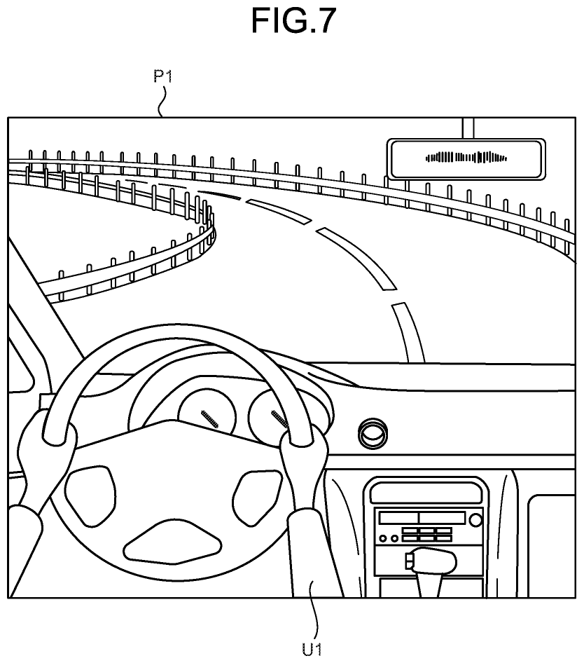

Here, the virtual image generated by the generation unit 383 will be described. FIG. 7 is a view schematically illustrating an example of the virtual image generated by the generation unit 383. As illustrated in FIG. 7, the generation unit 383 generates a virtual image P1 based on the spatial information and the traffic information, which are acquired by the acquisition unit 381. Specifically, the generation unit 383 generates a virtual image of a driver's seat or the like, which corresponds to the image of the internal space of the moving body 1. Furthermore, the generation unit 383 acquires an image of a hand, an arm and the like, which are viewed from the viewpoint of the user U1, or generates a virtual image. The generation unit 383 acquires an image of the external space in which the moving body 1 travels, or generates a virtual image. The generation unit 383 combines the acquired image and the generated virtual image with each other, and generates the virtual image P1 viewed from the viewpoint of the user U1.

Subsequently, as illustrated in FIG. 6, the acquisition unit 381 acquires the so-called physical information such as the behavior information and vital information of the user U1 (step ST7). Note that the acquisition unit 381 may further acquire the user identification information for identifying the user U1. Specifically, the acquisition unit 381 acquires the behavior information detected by the behavior sensor 32 and the vital information detected by the wearing sensor 36. Moreover, the acquisition unit 381 may also acquire the iris of the user U1, which is detected by the line-of-sight sensor 33, as the user identification information for identifying the user U1. The acquisition unit 381 may acquire, in time series, the image data in which the user U1 is reflected, the image data being generated by the imaging unit 12 of the moving body 1. In this case, the control unit 38 may detect or acquire the behavior information of the user U1 by object detection processing using a known optical flow, image processing, or the like, which is performed for the time-series image data. Furthermore, the control unit 38 may detect the face of the user U1 by using the known template matching performed for the image corresponding to the image data, and may acquire the detected face as the user identification information.

Thereafter, based on the spatial information and the behavior information, which are acquired by the acquisition unit 381, the determination unit 382 determines whether or not the posture of the user U1 has changed, that is, whether or not the action data indicating the action of the user U1 is input to the acquisition unit 381 (step ST8). When the determination unit 382 determines that the action data as data of a predetermined action is not input (step ST8: No), the processing returns to step ST5. On the other hand, when the determination unit 382 determines that the action data is input (step ST8: Yes), the processing proceeds to step ST9.

Thereafter, the generation unit 383 generates a virtual image corresponding to the action data, and the output control unit 384 outputs the virtual image. Specifically, in response to the action of the user U1, the generation unit 383 generates the virtual image viewed from the viewpoint of the user U1 or the bird's eye viewpoint by using the spatial information acquired by the acquisition unit 381. The output control unit 384 outputs the virtual image P1 and a virtual image P2, which are generated by the generation unit 383, to the projection unit 34, and projects the same toward the retina of the user U1.

For example, when the user U1 performs an action to turn the steering wheel illustrated in FIG. 7, the virtual image P1 generated by the generation unit 383 is a virtual image in which the steering wheel is turned by the hands of the user U1. Moreover, a scene of the external space changes with the passage of time. Thus, the user U1 may recognize that the virtual image responds to the action performed by the user U1, him/herself. Thus, the user U1 may obtain such a sense to drive the moving body 1, and may enjoy the pleasure of operating the moving body 1.

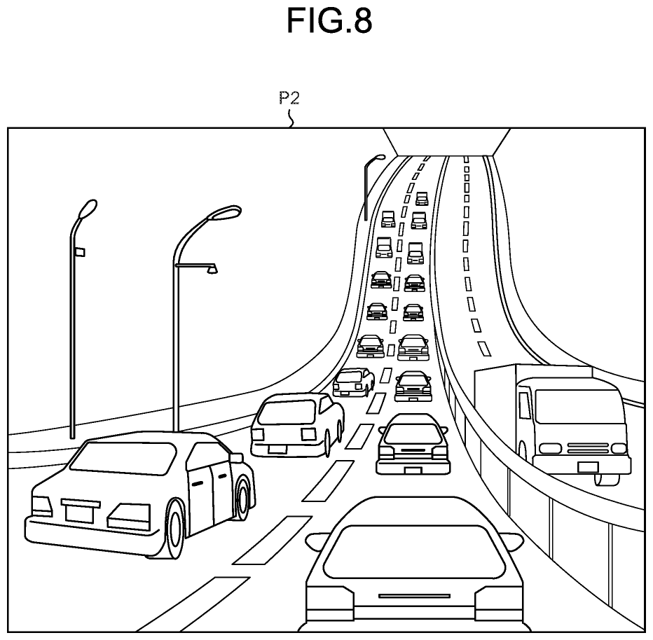

Further, for example, when the user U1 performs an action similar to that of a bird as a preset action, the virtual image P2 generated by the generation unit 383 is such a virtual image, for example, as illustrated in FIG. 8, in which a viewpoint moves vertically upward from the moving body 1. Note that the preset action is not necessarily limited to the action similar to that of a bird, and it is possible to set any action. FIG. 8 is a diagram schematically illustrating an example of a virtual image generated by the generation unit 383, in which a road and the like are overlooked. FIG. 8 is a virtual image P2 illustrating a situation especially during a traffic congestion.

As illustrated in FIG. 8, the generation unit 383 generates a virtual image of lines of cars and the like on a road, which is viewed from a viewpoint moved vertically upward from the moving body 1 on which the user U1 rides, based on the spatial information and the traffic information, which are acquired by the acquisition unit 381. In this case, for example, an illustration image or the like may be used for the road and other forward moving bodies, which are included in the virtual image P2. The illustration image may be generated based on the spatial information and the traffic information, which are acquired by the acquisition unit 381. Here, in the virtual image P2 illustrated in FIG. 8, a traffic congestion state on the road on which the moving body 1 travels is drawn. That is, the number of moving bodies in the traffic congestion state is calculated based on traffic information such as traffic congestion information, and the moving bodies are virtually depicted by the calculated number. Moreover, from the information on the moving body 1 on which the user U1 rides, such a virtual image that displays the traffic congestion state on a map may be generated, or a virtual image in which a state of the beginning of the traffic congestion is depicted may be generated. Further, character information may be superimposed on the virtual image P2 illustrated in FIG. 8. In this case, if the beginning of the traffic congestion is a traffic accident scene, the situation of the accident may be visually drawn or output in text or voice based on traffic information contents including the accident information.

Thus, the user U1 may recognize the current situation around the moving body 1. For example, when the moving body 1 is involved in a traffic congestion, the user U1 may recognize the state of the beginning of the traffic congestion and the like from the virtual image P2. Therefore, the user U1 may visually recognize how much traffic congestion the user U1 is involved in, so that an effect of alleviating a stress and anxiety caused by the traffic congestion may be expected.

Next, in step ST10 illustrated in FIG. 6, the determination unit 382 determines whether or not the travel unit 18 is controllable by the operation control. For example, the determination unit 382 calculates a safety level of the moving body 1 based on the image data acquired by the acquisition unit 381 from the imaging unit 12 of the moving body terminal device 10, based on the position information of the moving body 1 and the traffic information at the current position. When the determination unit 382 determines that the safety level of the moving body 1 meets a predetermined standard (step ST10: Yes), the processing proceeds to step ST12. Here, for example, when the safety level is derived with a numerical value, and a larger numerical value indicates a higher safety level, the determination unit 382 determines that the safety level meets the predetermined standard when the derived numerical value of the safety level is a predetermined value or more. On the contrary, when the safety level is derived with a numerical value, and a smaller numerical value indicates a higher safety level, the determination unit 382 determines that the safety level meets the predetermined reference when the derived numerical value of the safety level is a predetermined value or less.

On the other hand, when the determination unit 382 determines that the safety level of the moving body 1 does not meet the standard (step ST10: No), the processing proceeds to step ST11. The travel control unit 385 of the control unit 38 disconnects the control of the travel unit 18 (step ST11). Specifically, the control unit 38 blocks or stops the transmission of the control signal for controlling the travel unit 18 from the travel control unit 385 to the moving body terminal device 10. In this case, the moving body terminal device 10 continues to control the travel unit 18 by the control signal based on the control program for the autonomous driving. Thus, even if the travel unit 18 is configured to be controllable in response to the action and utterance of the user U1, the travel unit 18 may be made incontrollable when the safety may not be ensured, and accordingly, the safety of the moving body 1 may be ensured.

Here, the safety level may be calculated based on various parameters. Specifically, the safety level may be calculated based on values obtained by quantifying a distance to the front and rear moving bodies 1, a travel route, a speed and an acceleration, whether or not an emergency vehicle or the like is present in the vicinity, and the like in the moving body 1 on which the user U1 rides. Moreover, the safety level may be calculated based on the number of signals and pedestrian crossings on the roads on which the moving body 1 travels, the number of pedestrians in the vicinity, values obtained by quantifying weather conditions, road conditions, and the like. Note that the safety level of the moving body 1 may be calculated by using a trained model generated by machine learning.

Moreover, as a method for the determination unit 382 to determine whether or not the travel unit 18 is controllable by the operation control, a method other than the determination using the safety level may be adopted. For example, the determination unit 382 may determine whether or not the travel unit 18 is controllable by the operation control by determining whether or not the moving body 1 is involved in the traffic congestion. In this case, the determination unit 382 may determine that the moving body 1 is involved in the traffic congestion when the vehicle speed of the moving body 1 is a predetermined speed or lower for a predetermined time or longer. The predetermined speed may be arbitrarily set, for example, to 10 km/h or the like, and the predetermined time may also be arbitrarily set, for example, to 10 minutes or the like. Further, the determination unit 382 may determine whether or not the moving body 1 is involved in the traffic congestion at the current position based on the traffic information acquired by the acquisition unit 381. For example, based on the traffic information, the determination unit 382 may determine that the moving body 1 is involved in the traffic congestion when stop and start states are repeated for 15 minutes or more and the lines of cars are 1 km or more. Note that various methods may be used to determine whether or not the moving body 1 is involved in the traffic congestion. In the case of having determined that the moving body 1 is involved in the traffic congestion, the determination unit 382 may determine that the travel unit 18 is controllable by the operation control, but in the case of having determined that the moving body 1 is involved in the traffic congestion, the determination unit may determine that the control of the travel unit 18 by the operation control is impossible.

As a method for the determination unit 382 to determine whether or not the travel unit 18 is controllable by the operation control, the above-mentioned determination using the safety level and the determination as to whether or not the traffic congestion is present may be combined with each other. For example, in the case of having determined that the moving body 1 is involved in the traffic congestion or in the case of having determined that the safety level in the moving body 1 is a predetermined value or more, the determination unit 382 may determine that the travel unit 18 is controllable by the operation control.

Next, in step ST12, based on the action data of the user U1, which is acquired by the acquisition unit 381, the travel control unit 385 outputs the control signal corresponding to the action data, and controls the travel unit 18 of the moving body 1 via the moving body terminal device 10. Hereinafter, a specific example of control for the moving body 1, which uses the first wearable device 30, will be described.

Specifically, for example, the virtual image P1 or the like illustrated in FIG. 7 is a virtual image viewed from the line of sight of the user U1. For example, when the user U1 performs such an action to turn the steering wheel, a control signal for causing the travel unit 18 to change a travel path is transmitted thereto. The travel unit 18 that has received the control signal controls the steering unit 182 to change the steering angle of the wheels of the moving body 1. Thus, the travel direction of the moving body 1 is changed in response to the turning of the steering wheel by the user U1.

Moreover, character information corresponding to the travel path on which the moving body 1 is autonomously driven may be displayed. Specifically, for example, when the moving body 1 travels on a travel path that turns to the left, character information such as “turn the steering wheel to the left” is displayed on the virtual image P1, thus notifying the user U1 of the action. When the user U1 turns the steering wheel to the left in response to this, the steering unit 182 of the travel unit 18 may be controlled at timing associated with the action, and the moving body 1 may be operated so as to turn to the left.

Furthermore, for example, when a virtual image of a hand-turning handle is displayed, and the user U1 performs such an action to rotate the hand-turning handle on the virtual image, an amount of exercise of the action of the user U1 may be calculated to charge a battery in response to the amount of exercise. Specifically, the battery may be charged by changing an engine speed in the drive unit 181 of the travel unit 18, and so on based on the calculated amount of exercise of the user U1. Note that such a configuration may be adopted in which the moving body 1 is provided with an operator such as an actually rotated hand-turning handle and a generator, and electricity is generated by actually operating the operator such as a hand-turning handle in matching with the virtual image, and the electricity is stored in the battery. Furthermore, a predetermined coefficient may be set based on the vital information of the user U1, which is detected by the wearing sensor 36, and the calculated amount of exercise may be multiplied by a predetermined count to change the control of the operation of the user U1 for the drive unit 181. For example, setting of the amount of exercise for increasing the engine speed by 100 rpm may be increased in an athlete mode or the like and may be decreased in a normal mode or the like.

Moreover, for example, when a virtual image of a brake, an accelerator and the like is displayed and the user U1 performs an action of stepping on the accelerator, it is also possible to increase the engine speed and to accelerate the moving body 1 by controlling the drive unit 181 of the travel unit 18. Likewise, when the user U1 performs an action of stepping on the brake, it is possible to reduce the speed of the moving body 1 by controlling the drive unit 181 of the travel unit 18.

Further, while the user U1 is performing the action, the control to the travel unit 18 may be disconnected in steps ST10 and ST11 illustrated in FIG. 6. In this case, the control signal from the travel control unit 385 is not input to the travel unit 18, and the control by the operation control is interrupted. Even in this case, the generation and projection of the virtual images P1 and P2 may be continued. Then, the action of the user U1 during a period while the control to the travel unit 18 is disconnected may be stored in the control unit 38, and may be reflected on the control to the travel unit 18 when the control to the travel unit 18 is enabled. Furthermore, the travel control unit 385 may control the reclining function and the like of the seat portion 191 in response to the virtual image generated by the generation unit 383, the action of the user U1, and the like, and may change the state of the seat inside the moving body 1.

Subsequently, as illustrated in FIG. 6, when an instruction signal for instructing the end is input to the control unit 38 (step ST13: Yes), the processing is ended. Various methods may be adopted as a method of inputting the instruction signal for instructing the end to the control unit 38. For example, it is possible to input the instruction signal for instructing the end by, for example, performing the action of stepping on the brake or inputting predetermined information to the input unit 14 or the like of the moving body 1. On the other hand, if the instruction signal for instructing the end is not input to the control unit 38 (step ST13: No), the processing returns to step ST5. From the above, the travel control of the moving body 1 by the first wearable device 30 is ended.

When the moving body is a moving body capable of autonomous travel, the driving operation by the user becomes unnecessary while the user is riding on the moving body and moving. Moreover, also when the user rides on and drives the moving body, traffic congestion may occur. Even in such a case, according to the embodiment, which is described above, the user U1 who rides on the moving body 1 performs the action, which corresponds to the virtual image projected on the projection unit 34 of the first wearable device 30, while viewing the virtual image, and may thereby operate the moving body 1. Thus, the user U1 becomes capable of enjoying the pleasure of riding on the moving body 1 and the pleasure of operating the moving body 1.

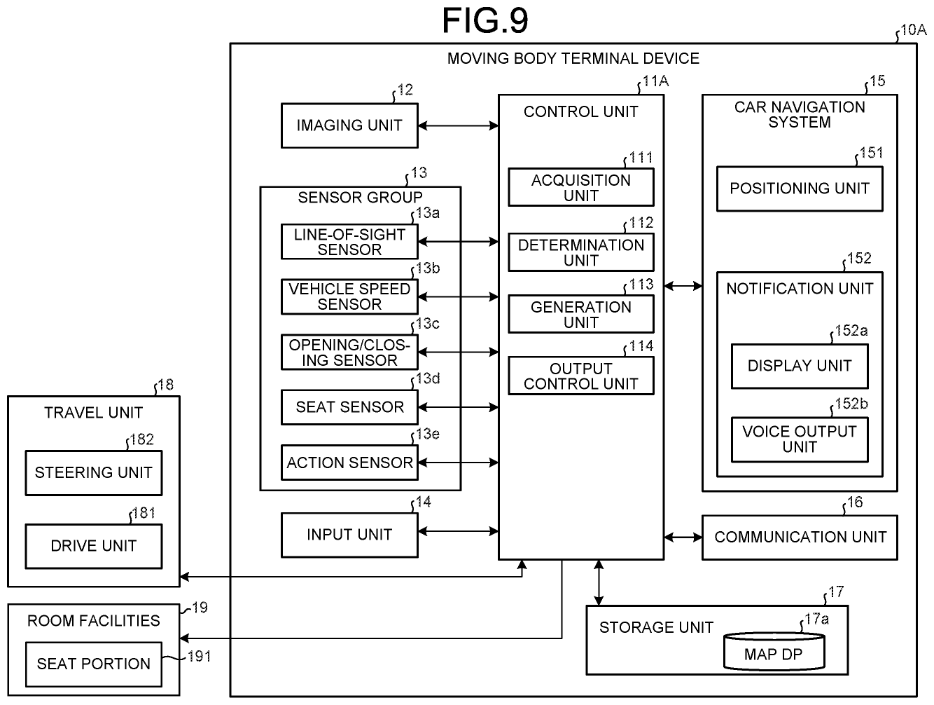

FIG. 9 is a block diagram illustrating a functional configuration of a moving body terminal device according to a modification of the embodiment. A moving body terminal device 10A illustrated in FIG. 9 includes a control unit 11A instead of the control unit 11 of the moving body terminal device 10 according to the above-mentioned embodiment, and in addition, the sensor group 13 includes an action sensor 13e. The control unit 11A physically has the same configuration as the control unit 11. The control unit 11A includes an acquisition unit 111, a determination unit 112, a generation unit 113, and an output control unit 114. The acquisition unit 111, the determination unit 112, the generation unit 113, and the output control unit 114 are the same as the acquisition unit 381, the determination unit 382, the generation unit 383, and the output control unit 384, which are mentioned above, respectively. The action sensor 13e as a second sensor detects the action of the user U1 in the moving body 1. In the first modification, the control unit 11A functions as a processor of the moving body control device.

In the first modification, a virtual image generated by the generation unit 113 is displayed on the display unit 152a. The action of the user U1 is captured by the imaging unit 12 or detected by the action sensor 13e. Thus, the acquisition unit 111 of the control unit 11 may acquire the behavior information of the user U1. Moreover, the user U1 may wear a wristwatch-type wearable device capable of acquiring the vital information of the user U1 and the like and capable of communicating with the communication unit 16. Then, the vital information of the user U1 may be transmitted from the wearable device worn by the user U1 via the communication unit 16 to the acquisition unit 111 of the moving body terminal device 10A. Thus, the determination unit 112 may make a determination based on the vital information of the user U1. With the above configuration, also in the first modification, the same effect as that of the above-mentioned embodiment may be obtained.

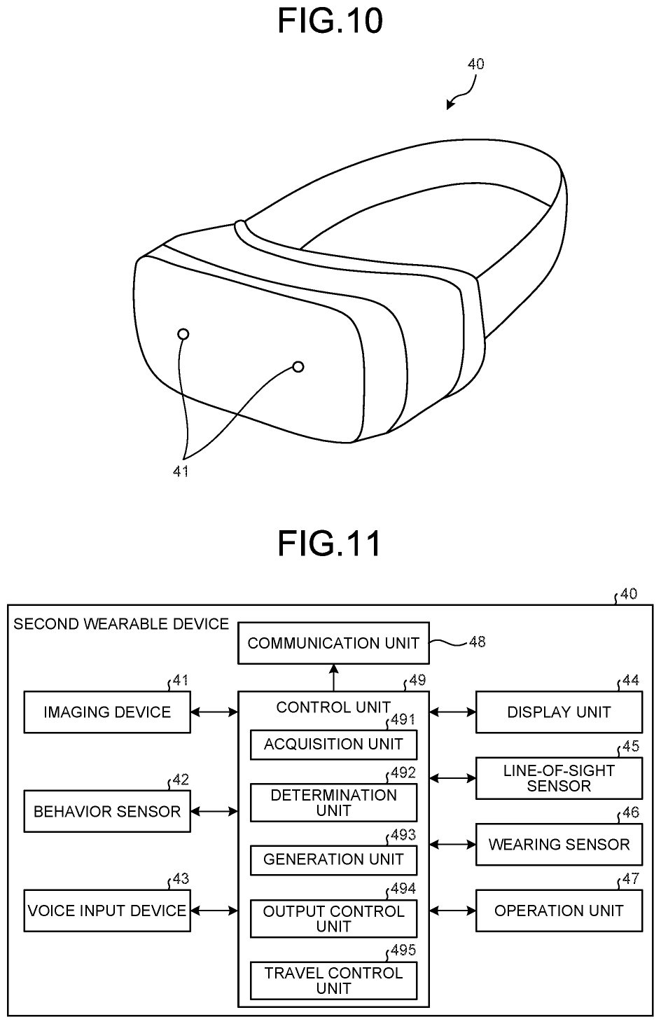

Next, a description will be given of the second wearable device 40 according to a second modification of the embodiment. FIG. 10 is a view illustrating a schematic configuration of the second wearable device 40. FIG. 11 is a block diagram illustrating a functional configuration of the second wearable device 40.

The second wearable device 40 as a moving body control device illustrated in FIGS. 10 and 11 is a head mounted display (HMD) for so called mixed reality (MR) or virtual reality (VR). The second wearable device 40 displays, to the user U2, stereoscopically visible image, video, character information and the like, in which a real world is superimposed on a virtual world (digital space). The second wearable device 40 includes imaging devices 41, a behavior sensor 42, a voice input device 43, a display unit 44, a line-of-sight sensor 45, a wearing sensor 46, an operation unit 47, a communication unit 48, and a control unit 49. The imaging devices 41, the behavior sensor 42, the line-of-sight sensor 45, the wearing sensor 46, the communication unit 48, and the control unit 49 have the same configurations as those of the imaging device 31, the behavior sensor 32, the line-of-sight sensor 33, the wearing sensor 36, the communication unit 37, and the control unit 38 in the first wearable device 30, respectively. In the second modification, the control unit 49 functions as a processor of the moving body control device.

As illustrated in FIG. 10, a plurality of the imaging devices 41 as the first sensor are provided in the second wearable device 40. Under control of the control unit 49, the imaging devices 41 capture an image along the line of sight of the user U2, thereby generating two image data having a parallax therebetween, and outputting these image data to the control unit 49.

As illustrated in FIG. 11, the behavior sensor 42 as a second sensor detects behavior information regarding a behavior of the user U2 wearing the second wearable device 40, and outputs a detection result to the control unit 49. The voice input device 43 receives an input of the voice of the user U2 and outputs audio data corresponding to the received voice to the control unit 49. The voice input device 43 is composed by using a microphone, an A/D conversion circuit that converts, into audio data, a voice input to the microphone, and an amplifier circuit that amplifies the audio data.

Under the control of the control unit 49, the display unit 44 displays stereoscopically visible image, video, character information, and the like. The display unit 44 is composed by using a pair of left and right display panels having a predetermined parallax therebetween. The display panel is composed by using liquid crystal, organic electro luminescence (EL) or the like. The operation unit 47 receives an input of the operation of the user U2, and outputs a signal corresponding to the received operation to the control unit 49. The operation unit 47 is composed by using buttons, switches, a jog dial, a touch panel, or the like.

The control unit 49 controls operations of the respective units which compose the second wearable device 40. The control unit 49 includes an acquisition unit 491, a determination unit 492, a generation unit 493, an output control unit 494, and a travel control unit 495. The acquisition unit 491, the determination unit 492, the generation unit 493, the output control unit 494, and the travel control unit 495 are the same as the acquisition unit 381, the determination unit 382, the generation unit 383, the output control unit 384, and the travel control unit 385, which are mentioned above, respectively.

In the second modification, the virtual image generated by the generation unit 493 is displayed on the display unit 44. The action of the user U2 is captured by the imaging devices 41 or detected by the behavior sensor 42. Thus, the acquisition unit 491 of the control unit 49 may acquire the action information of the user U2. With the above configuration, also in the second modification, the same effect as that of the above-mentioned embodiment may be obtained.

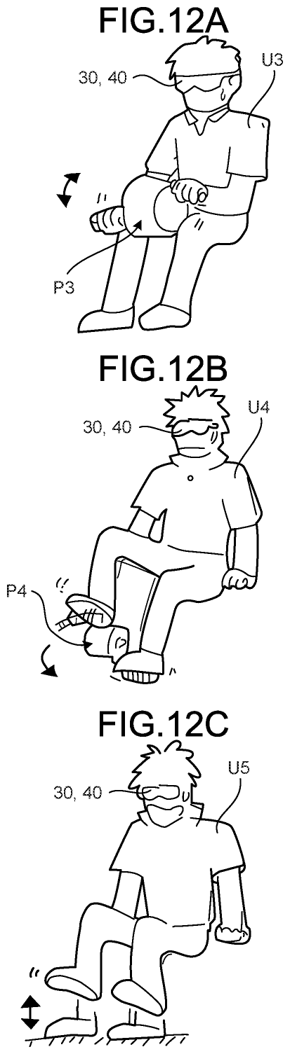

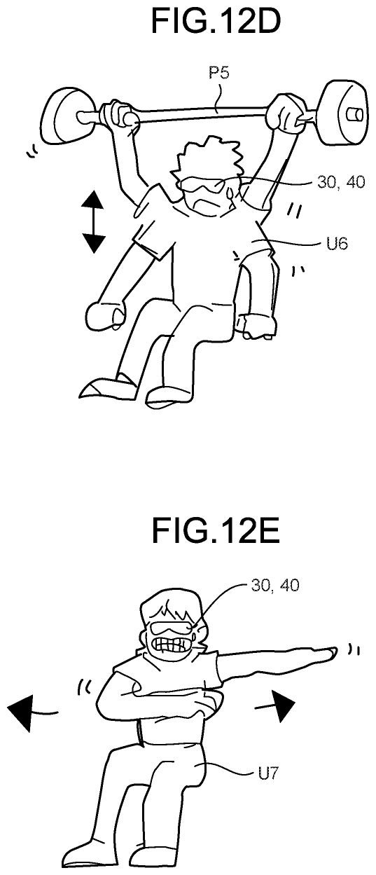

Next, a description will be given of an example of a virtual image displayed by the wearable device 30 or 40 according to a third modification of the embodiment and a user's action corresponding to the virtual image. FIGS. 12A to 12E are views for explaining examples of the user's actions and examples of virtual images visually recognized by the user according to the third to seventh modifications.

In the third modification, as illustrated in FIG. 12A, a user U3 wearing the wearable device 30 or 40 may visually recognize a virtual image P3, for example, such as a hand-rolling roller. Note that, though a normal state is where only the user U3 visually recognizes the hand-rolling roller of the virtual image P3 by the wearable device 30 or 40, the hand-rolling roller may be actually used to cause the user U3 to actually roll the hand-rolling roller in response to a video of the virtual image P3 or the like. The wearable device 30 or 40 may transmit a control signal to the moving body terminal device 10 of the moving body 1 in response to the action of rotating the hand-rolling roller of the virtual image P3 by the user U3 and to an amount of the action, may control the engine speed and the like, and may charge the battery with an amount of electric power, which corresponds to the amount of action. Moreover, the wearable device 30 or 40 may notify the user U3 of a charge amount.

In the fourth modification, as illustrated in FIG. 12B, a user U4 wearing the wearable device 30 or 40 may visually recognize a virtual image P4, for example, such as a foot roller. Note that, though a normal state is where only the user U4 visually recognizes the foot roller of the virtual image P4 by the wearable device 30 or 40, the user U4 may actually use the foot roller, and the user U4 may actually pedal the foot roller in response to a video of the virtual image P4 or the like. The wearable device 30 or 40 may transmit, to the moving body terminal device 10, a control signal corresponding to an action of pedaling the foot roller of the virtual image P4 by the user U4 and an amount of such a pedaling action. In this case, the speed and the like of the engine may be controlled to charge the battery in response to the amount of pedaling action by the user U4, and the moving body 1 may be moved in response to the amount of pedaling action by the user U4. Moreover, the wearable device 30 or 40 may notify the user U4 of the amount of charge in the battery and the amount of movement of the moving body 1.

In the fifth modification, as illustrated in FIG. 12C, for example, when a user U5 wearing the wearable device 30 or 40 performs stepping and thigh raising, the wearable device 30 or 40 may be caused to transmit, to the moving body terminal device 10, a control signal corresponding to such a stepping or thigh raising action and to an amount of the action. Note that the wearable device 30 or 40 may be caused to output, to the user U5, a display or a voice, which prompts the user U5 to perform the stepping or the thigh raising. In this case, the user U5 performs the action such as the stepping and the thigh raising in response to the output from the wearable device 30 or 40. The moving body terminal device 10 may control the engine speed, a gear stage and the like in response to the stepping and the thigh raising, which are performed by the user U5, the number of times of these exercises, and the like, and may charge the battery, move the moving body 1, and so on. Moreover, the wearable device 30 or 40 may notify the user U5 of the amount of charge in the battery and the amount of movement of the moving body 1.

In the sixth modification, as illustrated in FIG. 12D, a user U6 wearing the wearable device 30 or 40 may visually recognize a virtual image P5, for example, such as a dumbbell. Note that, though a normal state is where only the user U6 visually recognizes the dumbbell of the virtual image P5 by the wearable device 30 or 40, the dumbbell, a bar or the like may be actually used to cause the user U6 to actually move the dumbbell, the bar or the like up and down in response to a video of the dumbbell or the like in the virtual image P5. The wearable device 30 or 40 may transmit a control signal to the moving body terminal device 10 in response to the action of moving the dumbbell of the virtual image P5 up and down by the user U6 and to an amount of the action, may control the engine speed and the like, and may charge the battery with an amount of electric power, which corresponds to the amount of action. Moreover, the wearable device 30 or 40 may notify the user U6 of a charge amount.

In the seventh modification, as illustrated in FIG. 12E, for example, when a user U7 wearing the wearable device 30 or 40 performs an exercise to shake arms from side to side, the wearable device 30 or 40 may be caused to transmit, to the moving body terminal device 10, a control signal corresponding to such an action of the arms and an amount of the action. Note that the wearable device 30 or 40 may be caused to output, to the user U7, a display or a voice, which prompts the user U7 to perform a stepping action. In this case, the user U7 performs the action such as the stepping in response to the output from the wearable device 30 or 40. The moving body terminal device 10 may control the engine speed, the gear stage and the like in response to the stepping performed by the user U7, the number of times of the exercise, and the like, and may charge the battery, move the moving body 1, and so on. Moreover, the wearable device 30 or 40 may notify the user U7 of the amount of charge in the battery and the amount of movement of the moving body 1.

The above-mentioned user U1 is mainly a driver, but the users U2 to U7 may be drivers or fellow passengers on the moving body 1. Thus, the fellow passengers other than the driver may recognize a peripheral region of the moving body 1 or control the moving body 1 by their own actions corresponding to the virtual image, and accordingly, may enjoy the pleasure of riding on the moving body 1. Moreover, in each of the above-mentioned third to seventh modifications, the description is given of an example in which the battery is charged or the moving body 1 is moved in response to the user's action, but the objects to be controlled are not necessarily limited to the charge of the battery and the movement of the moving body 1. That is, various controls for the moving body 1, which correspond to the user's action, may be arbitrarily set.

In the above-mentioned embodiment, a program to be executed by the moving body terminal device, the first wearable device or the second wearable device may be recorded in a recording medium readable by a computer, other machines or a device such as a wearable device (hereafter, referred to as a computer or the like). The computer or the like is caused to read and execute the program in the recording medium, whereby the computer or the like functions as the moving body control device. Here, the recording medium readable by a computer or the like refers to a non-transitory recording medium configured to electrically, magnetically, optically, mechanically, or chemically store information, such as data and programs, so as to be read by a computer or the like. Such a recording medium includes recording media removable from the computer or the like, for example, such as flexible disks, magneto-optical disks, CD-ROMs, CD-R/Ws, DVDs, BDs, DATs, magnetic tapes, and memory cards such as flash memories. Furthermore, a recording medium fixed to the computer or the like include hard disks, ROMs, and the like. Moreover, a solid state drive (SSD) may be used as a recording medium removable from the computer or the like, and also as a recording medium fixed to the computer or the like.

Furthermore, the program to be executed by the vehicle terminal device, the first wearable device, the second wearable device and the server according to the embodiment may be stored on a computer connected to a network such as the Internet and configured to be downloaded via the network to be provided.

Although the embodiment has been specifically described above, the present disclosure is not limited to the embodiment mentioned above, and various modifications based on the technical idea of the present disclosure may be adopted. For example, the virtual images and the actions, which are described in the above embodiment, are merely examples, and different virtual images and operations may be used.

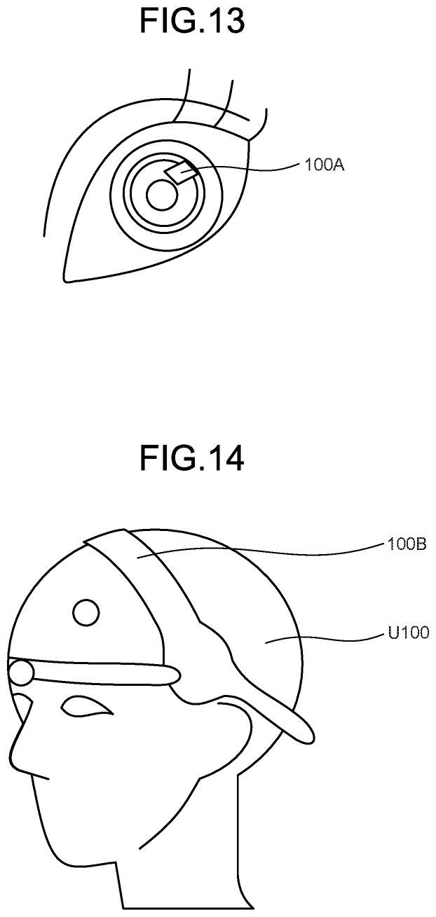

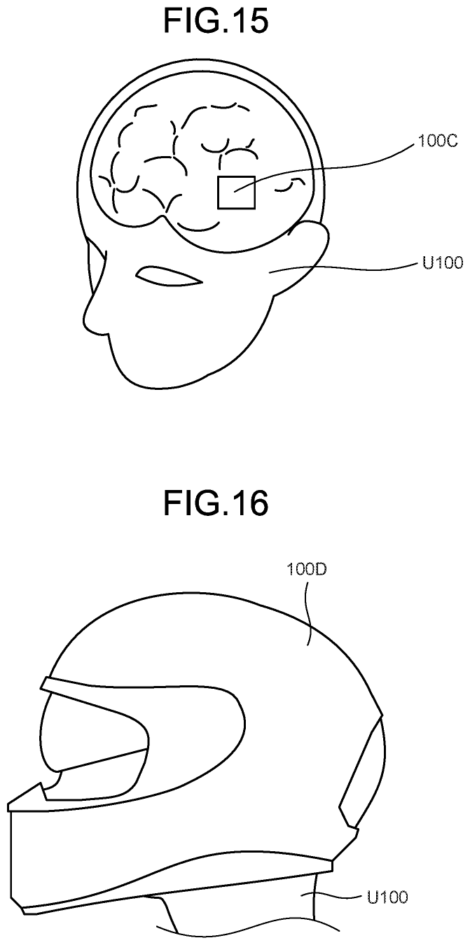

In the above-mentioned embodiment, the description is given of the examples of using the eyeglass-type wearable device and the wristwatch-type wearable device, which may be worn by the user, but the present disclosure is not limited to these, and the above-mentioned embodiment may be applied to various wearable devices. For example, as illustrated in FIG. 13, the above-mentioned embodiment may be applied to a contact lens-type wearable device 100A having an imaging function. Further, the above-mentioned embodiment may also be applied to a wearable device 100B illustrated in FIG. 14 or a brain chip-type wearable device 100C illustrated in FIG. 15, which is a device that directly transmits information directly to the brain of a user U100. Moreover, like a wearable device 100D illustrated in FIG. 16, the wearable device may be formed into a helmet shape including a visor. In this case, the wearable device 100D may project and display an image on the visor.

Further, according to the above-mentioned embodiment, the first wearable device projects an image onto the retina of the user U1 to cause the user U1 to view the image. Alternatively, the first wearable device may be a device that projects and displays an image onto the lens 39 of, for example, glasses.

Moreover, in the embodiment, the “units” mentioned above may be replaced with “circuits” and the like. For example, the control unit may be replaced with a control circuit.

Meanwhile, in the description of the flowchart in the present specification, although the expressions “first”, “then”, “subsequently”, and the like are used to clarify a processing order of the steps, the processing order to carry out each of the present embodiments shall not be defined uniquely by these expressions. That is, the processing order in the flowchart described in the present specification may be changed unless it is inconsistent.

According to some embodiments, the riding user may perform an action corresponding to the virtual image while viewing the virtual image, and may control the moving body in response to the action of the user. Accordingly, it becomes possible for the user who rides on the moving body to enjoy the pleasure of riding on the same.

According to some embodiments, the moving body may be controlled while traveling safety of the moving body is ensured, so that the user who rides on the same may feel a sense of security.

According to some embodiments, since the control of the moving body may be executed while the moving body is involved in the traffic congestion, the user who rides on the moving body may enjoy the time even during the traffic congestion, and boredom and stress which the user is likely to feel in a situation of being involved in the traffic congestion may be alleviated.

According to some embodiments, the user may visually recognize the external situation, and therefore, for example, when the moving body is involved in the traffic congestion, the traffic congestion may be recognized in a bird's-eye view, and therefore, the stress and anxiety which the user is likely to feel due to the traffic congestion may be alleviated.

According to some embodiments, even if the user performs various actions, the user may visually recognize the virtual image displayed on the display unit, so that the sense of presence, which is received by the user, may be maintained.

According to some embodiments, the riding user may perform an action corresponding to the virtual image while viewing the virtual image, and may control the moving body in response to the action of the user. Accordingly, it becomes possible for the user who rides on the moving body to enjoy the pleasure of riding on the same.

According to some embodiments, the riding user may perform an action corresponding to the virtual image while viewing the virtual image, and may control the moving body in response to the action of the user. Accordingly, it becomes possible for the processor to execute processing for enabling the user who rides on the moving body to enjoy the pleasure of riding on the same.

In accordance with the moving body control device, the moving body control method and the program according to the present disclosure, the riding user may perform the action corresponding to the virtual image while viewing the virtual image, and may control the moving body in response to the action of the user. Accordingly, it becomes possible for the user who rides on the moving body to enjoy the pleasure of riding on the same.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A moving body control device comprising
a processor comprising hardware, the processor being configured to:
acquire spatial information of at least one of an outside and inside of a moving body;
generate a virtual image including the information of the at least one of the outside and inside of the moving body based on the spatial information;
output the generated virtual image to a display unit visually recognizable by a user who rides on the moving body;
acquire a detection result of a predetermined action of the user when the user performs an action;
update and output the virtual image based on the action of the user in the detection result; and
output a control signal for the moving body, the control signal being based on the detection result.

2. The moving body control device according to claim 1, wherein the processor is configured to:
calculate a safety level of the moving body; and
output the control signal to the moving body when the safety level satisfies a predetermined standard.

3. The moving body control device according to claim 1, wherein the processor is configured to:
acquire position information of the moving body and traffic information based on the position information; and
output the control signal to the moving body in a case of having determined that the moving body is involved in a traffic congestion based on the traffic information.

4. The moving body control device according to claim 1, wherein the processor is configured to:
acquire position information of the moving body and traffic information based on the position information;
generate a virtual image in which an external state of the moving body is viewed from a viewpoint above the moving body based on the traffic information when the user performs a preset action; and
output the generated virtual image to the display unit.

5. The moving body control device according to claim 1, wherein the display unit is provided on a wearable device worn by the user.

6. A method of controlling a moving body, the method comprising:
acquiring spatial information of at least one of an outside and inside of a moving body from a first sensor;
generating a virtual image including the information of the at least one of the outside and inside of the moving body based on the spatial information;
outputting the generated virtual image to a display unit visually recognizable by a user who rides on the moving body;
acquiring a detection result of a predetermined action of the user when the user who rides on the moving body performs an action, the detection result being detected by a second sensor;
updating and outputting the virtual image based on the action of the user in the detection result; and
outputting a control signal for the moving body to control the moving body, the control signal being based on the detection result.

7. A non-transitory computer-readable recording medium on which an executable program is recorded, the program causing a processor of a computer to execute:
acquiring spatial information of at least one of an outside and inside of a moving body;
generating a virtual image including the information of the at least one of the outside and inside of the moving body based on the spatial information;
outputting the generated virtual image to a display unit;
acquiring a detection result of a predetermined action of the user when the user who rides on the moving body performs the action;
updating and outputting the virtual image based on the action of the user in the detection result; and
outputting a control signal for the moving body to control the moving body, the control signal being based on the detection result.
